(19) United States
(12) Patent Application Publication
(10) Pub. No.: US 2024/0069866 A1
(43) Pub. Date: Feb. 29, 2024

(54) METHOD AND APPARATUS FOR PERFORMING FLOATING-POINT OPERATION USING MEMORY PROCESSOR

(71) Applicant: SAMSUNG ELECTRONICS CO., LTD., Suwon-si (KR)

(72) Inventors: Jinseong KIM, Suwon-si (KR); Jinpil LEE, Suwon-si (KR); Seungwon LEE, Suwon-si (KR)

(73) Assignee: SAMSUNG ELECTRONICS CO., LTD., Suwon-si (KR)

(21) Appl. No.: 18/115,032

(22) Filed: Feb. 28, 2023

(30) Foreign Application Priority Data
Aug. 26, 2022 (KR) 10-2022-0107934

(51) Int. Cl. G06F 7/487; G06F 9/50; G06F 17/16

(52) U.S. Cl. CPC G06F 7/4876; G06F 9/5027; G06F 17/16

(57) ABSTRACT

A method of performing a floating-point operation using a memory processor (the floating-point operation being a multiplication of a first matrix and a second matrix that are double-precision floating-point matrices) includes: determining whether an emulation is to be used to perform the floating-point operation, based on a result of the determining whether the emulation is to be used, determining whether to use the memory processor for the emulation, the emulation comprising stages, based on a result of the determining whether to use the memory processor for the emulation, individually determining whether to use the memory processor for each stage of the emulation, and multiplying the first matrix and the second matrix based on a result of the individually determining whether to use the memory processor.

### CROSS-REFERENCE TO RELATED APPLICATIONS

This application claims the benefit under 35 USC § 119(a) of Korean Patent Application No. 10-2022-0107934, filed on Aug. 26, 2022, in the Korean Intellectual Property Office, the entire disclosure of which is incorporated herein by reference for all purposes.

### BACKGROUND

### 1. Field

The following description relates to a method and apparatus for performing a floating-point operation using a memory processor.

### 2. Description of Related Art

A function of a memory device may be separated from a function of a processor for performing a computational task. A large amount of data may be transmitted and received between a memory device and a processor in a system such as a neural network, big data applications, an Internet of things (IoT), and the like, that require an operation for a large amount of data, and accordingly a memory-processor bottleneck phenomenon may frequently occur. Such a bottleneck is sometimes referred to as the Von Neumann bottleneck. To solve such an issue, research on a processor in memory (PIM) is being actively conducted as a memory device having both a function of a memory and a function of a processor for performing a computational task, typically, in a same chip. That is a memory chip may be provided with its own processor to allow computation without having to shuttle data to or from the memory chip.

As PIM research is actively conducted, PIM application fields are diversifying. For example, research on performing of artificial intelligence (AI) operations using PIM and research on processing for high performance computing (HPC) using PIM are being conducted. In particular, since it is important to accurately perform double-precision floating-point operations in HPC, research on method to accurately and quickly process double-precision floating-point operations may be important.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of performing a floating-point operation using a memory processor (the floating-point operation being a multiplication of a first matrix and a second matrix that are double-precision floating-point matrices) includes determining whether an emulation is to be used to perform the floating-point operation, based on a result of the determining whether the emulation is to be used, determining whether to use the memory processor for the emulation, the emulation comprising stages, based on a result of the determining whether to use the memory processor for the emulation, individually determining whether to use the memory processor for each stage of the emulation, and multiplying the first matrix and the second matrix based on a result of the individually determining whether to use the memory processor.

The determining whether the emulation is to be used may be based on whether an electronic device supports a double-precision floating-point operation.

The stages may include a splitting stage, a matrix multiplication operation stage, and a summation stage.

The splitting stage may include splitting the first matrix into a plurality of first sub-matrices and splitting the second matrix into a plurality of second sub-matrices; the matrix multiplication operation stage may include calculating matrix products between the first sub-matrices and the second sub-matrices; and the summation stage may include summing the matrix products.

The determining of whether to use the memory processor for the emulation may be based on at least one of a size of a matrix, a size of a sub-matrix, or a number of sub-matrices, the size of the matrix comprises at least one of a size of the first matrix or a size of the second matrix, and the number of sub-matrices may be determined based on at least one of a number of first sub-matrices or a number of second sub-matrices.

The size of the matrix may be determined based on at least one of a number of rows of the matrix, a number of columns of the matrix, or sizes of elements included in the matrix, wherein the sizes of the elements are determined based on ranges of double-precision floating-point numbers.

The number of sub-matrices may be determined based on a range of double-precision floating-point numbers.

The individually determining whether to use the memory processor for each stage of the emulation may include at least one of: determining whether to use the memory processor in a split stage; determining whether to use the memory processor in a matrix multiplication operation stage; or determining whether to use the memory processor in a summation stage.

The determining whether to use the memory processor in the split stage may be based on a comparison between a size of a sub-matrix and a memory bandwidth.

The memory processor may be determined to be used in the split stage when the size of the sub-matrix is less than the memory bandwidth.

The determining of whether to use the memory processor in the matrix multiplication operation stage may be based on at least one of a number of sub-matrices or floating-point operations per second (FLOPS).

The determining of whether to use the memory processor in the summation stage may be based on a comparison between a size of a sub-matrix and a memory bandwidth.

The multiplying of the first matrix and the second matrix may be controlled by at least one memory processor through a direct memory access (DMA) when the memory processor may be used for the emulation.

The first matrix and the second matrix may correspond to 64-bit floating point (FP64), and a sub-matrix obtained by splitting the matrix may correspond to at least one of 32-bit floating point (FP32), 16-bit floating point (FP16), 16-bit brain floating point (BF16), or tensor-float-32 (TF32).

A non-transitory computer-readable storage medium may store instructions that, when executed by a processor, cause the processor to perform any of the methods.

In one general aspect, an accelerator for performing a floating-point operation by receiving a floating-point operation request from a processor includes an accelerator core, a memory system, and a memory processor included in the memory system, and the accelerator is configured to: determine whether an emulation is to be used to perform the floating-point operation; based on a result of the determining whether the emulation is to be used, determine whether to use the memory processor for the emulation, the emulation comprising stages; based on a result of the determining whether to use the memory processor for the emulation, individually determine whether to use the memory processor for each stage of the emulation; and multiply a first matrix and a second matrix based on a result of the individually determining whether to use the memory processor.

In one general aspect, a computing device for a floating-point operation includes: a processor, a memory, and a memory processor included in the memory, and the processor, for performing the floating-point operation, is configured to: determine whether an emulation is needed for performing the floating-point operation; based on a result of the determining whether the emulation is needed, determine whether to use the memory processor for the emulation, wherein the emulation comprises stages; based on a result of determining whether to use the memory processor for the emulation, individually determine whether to use the memory processor for each stage of the emulation; and multiply a first matrix and a second matrix based on a result of the individually determining whether to use the memory processor.

The memory may include a memory chip, and the memory chip may comprise a memory portion and the memory processor.

The memory may be configured such that the memory processor may be capable of performing the multiplying on the first matrix and the second matrix stored while the first matrix and second matrix are stored in the memory portion.

The emulation may include multiplying the first matrix and the second matrix by splitting the first matrix and the second matrix into sub-matrices with smaller floating-point precision than the first and second matrices and multiplying the sub-matrices.

Other features and aspects will be apparent from the following detailed description, the drawings, and the claims.

### BRIEF DESCRIPTION OF THE DRAWINGS

FIG. 1 illustrates an example of an accelerator and a memory processor for a double-precision floating-point operation, according to one or more embodiments.

FIG. 2A illustrates an examples of an operation in which a portion of stages of a double-precision floating-point operation is performed in a memory processor, according to one or more embodiments.

FIG. 2B illustrates an example of an operation in which a portion of stages of a double-precision floating-point operation is performed in a memory processor, according to one or more embodiments

FIG. 3 illustrates an example of determining whether to use a memory processor in executing a double-precision floating-point operation, according to one or more embodiments.

FIG. 4A illustrates an example of performing a double-precision floating-point operation using a direct memory access (DMA), according to one or more embodiments.

FIG. 4B illustrates an example of performing a double-precision floating-point operation using a direct memory access (DMA), according to one or more embodiments

FIG. 5 illustrates an example in which a double-precision floating-point operation may be performed by an operation device with various number systems, according to one or more embodiments.

FIG. 6 illustrates an example of an operation of performing a double-precision floating-point operation using a processor, according to one or more embodiments.

FIG. 7 illustrates an example of a method of performing a double-precision floating-point operation using a memory processor, according to one or more embodiments.

FIG. 8 illustrates an example of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Hereinafter, examples will be described in detail with reference to the accompanying drawings. In the drawings, like reference numerals are used for like elements.

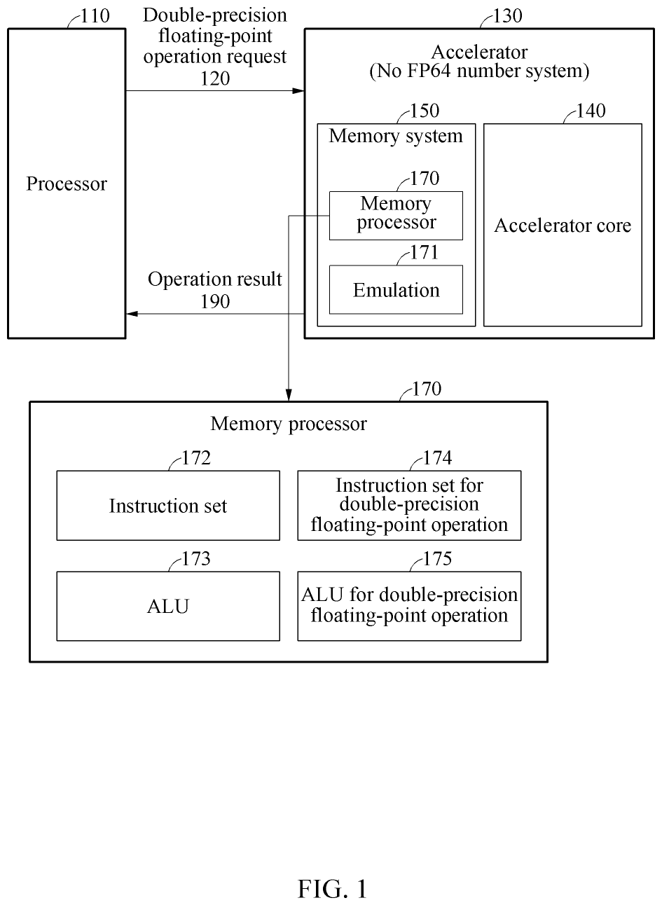

FIG. 1 illustrates an example of an accelerator and a memory processor for a double-precision floating-point operation, according to one or more embodiments.

In an example, the memory processor may be a processor in memory (PIM), which is an operation device provided in a memory system (e.g., a processor incorporated within a memory chip such as a DRAM chip). In another example, the memory processor may include a near memory processor connected to each of various memory units. The memory processor may perform various floating-point operations. By providing hardware and software (processor instructions) that may perform various floating-point operations, application fields of memory processors may be expanded to not only artificial intelligence (AI) but also high performance computing (HPC). In the field of AI, 16-bit floating point (FP16) representations may be mainly used. In HPC systems, 64-bit floating point (FP64) representations (double-precision floating point) may be used as a main operation/representation. Some devices support FP64 operations with software emulation when a hardware device does not support FP64. In general, FP64 has low floating-point operations per second (FLOPS) in comparison to FP16. However, since the FP64 is a main mode for performing simulations (e.g., weather models, fluid flow, etc.), double-precision floating-point (e.g., FP64) operations may be important in the HPC field.

Generally, emulation is a technique of mimicking part or all of an arbitrary system. Emulation may include software-based emulation and/or hardware-based emulation. Software-based emulation may be an emulation in which an operation usually performed by hardware is implemented and processed by software instead. For example, software-based emulation may include an emulation that performs processing using an FP64 operation algorithm (e.g., an Ozaki scheme) for an operator included in a memory system to support the FP64 operation. Hardware-based emulation may be an emulation provided to increase an efficiency of development (e.g., debugging, etc.) by enabling processing to obtain the same performance as existing hardware.

Floating-point emulation may emulate floating-point unit (FPU) hardware in a computer architecture that does not include the FPU. For example, floating-point emulation may be a scheme of performing, in a computer architecture, an operation of floating point (e.g., FP64) that is not natively included in the computer architecture. Such emulation may be based on floating point support (e.g., FP16, FP32, etc.) implemented in the computer architecture. An FP64 emulation, which is an algorithm for a double-precision floating-point operation, may be, for example, the Ozaki scheme. The Ozaki scheme may provide FP64 emulation of a general matrix-to-matrix multiplication (GEMM) between two matrices expressed by FP64 (e.g., FP64 elements), using FP16 hardware and without a rounding error (at least without rounding due to the emulation). FP64 emulation for GEMM may have great overhead. Accordingly, to reduce the overhead, a portion of stages of the FP64 emulation may be processed by a memory processor (i.e., using a processor-in-memory, a near-memory processor, or similar memory that allows computation such as math operations to be performed within the memory or without using a CPU-memory bus).

A delay may occur due to a bandwidth limit in data transmission between an accelerator (ACC) and a memory system. However, by offloading the double-precision floating-point operation to a memory processor, which is an operation device included in a memory, the delay caused by the bandwidth limit may be solved. Therefore, in an operation that requires wide bandwidth or in an operation that requires a large amount of data to be transmitted, a processor or an accelerator may perform a double-precision floating-point operation using the memory processor such that an operation performance may not exceed a memory bandwidth limit.

FIG. 1 illustrates a processor 110, an accelerator 130, an accelerator core 140, a memory system 150, a memory processor 170, an emulation 171, an instruction set 172, an arithmetic logic unit (ALU) 173, an instruction set 174 for a double-precision floating-point operation, an ALU 175 for a double-precision floating-point operation, a double-precision floating-point operation request 120, and an operation result 190.

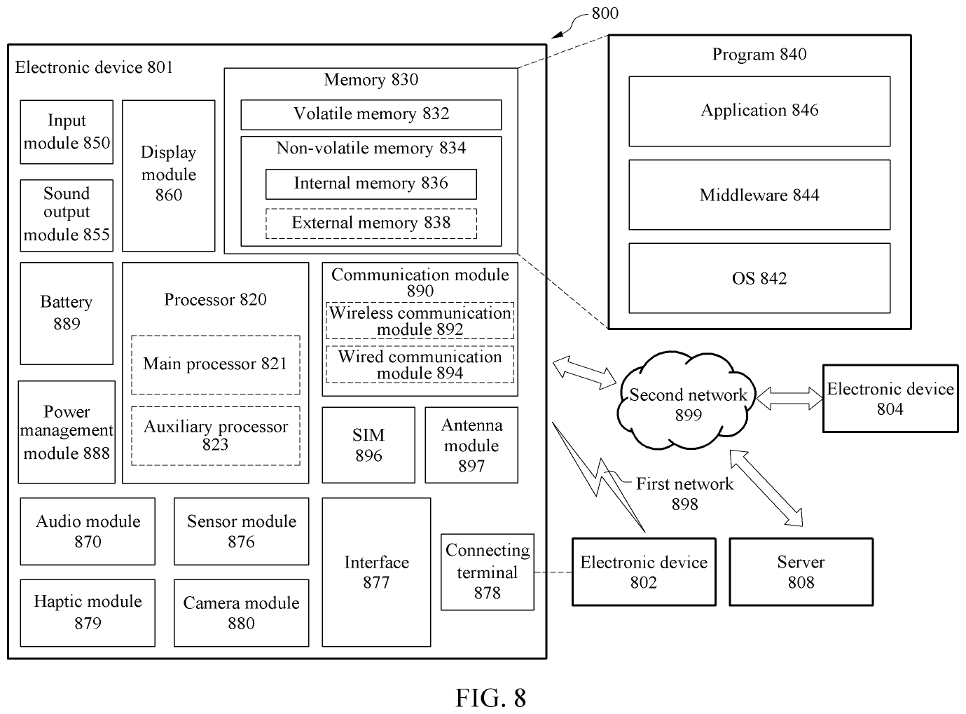

The processor 110 may correspond to a main processor 821 of FIG. 8. The processor 110, which is a central processing unit (CPU), may transmit an operation request to the accelerator 130.

The accelerator 130 may be a device for accelerating an operation for a predetermined purpose requested by the processor 110. The accelerator 130 may correspond to a coprocessor 822 of FIG. 8. The accelerator 130 may include, for example, a graphics processing unit (GPU), and/or a neural processing unit (NPU).

In an example, the accelerator 130 may be a device that does not natively support a double-precision floating-point operation. That is, the accelerator core 140 may not have double-precision FP primitives and/or may not have double-precision instructions in its instruction set (to be distinguished from the instruct set(s) of the memory processor 170). In another example, the accelerator 130 may be an accelerator that natively supports double-precision operations but performs them with low performance and so it may be desirable to avoid use thereof (e.g., by emulation), even when the accelerator 130 has been requested to perform a double-precision operation. A device that does not natively support a double-precision floating-point operation may still be capable of performing the double-precision floating-point operation using lower-precision floating points (e.g., FP16, FP32, etc.). Therefore, for such devices, emulation of the double-precision floating-point operation may use floating points other than double-precision floating points.

The accelerator core 140 may include an arithmetic logic unit (ALU) and a controller for controlling hardware included in the accelerator 130. Herein, an operation of the accelerator 130 may be understood to be an operation of the accelerator core 140 (as opposed to an operation of the memory processor 170).

The memory system 150 may correspond to a memory 830 of FIG. 8. The memory system 150 may include the memory processor 170. The memory system 150 may include at least one of a high bandwidth memory (HBM), a double data rate (DDR), and/or a random-access memory (RAM). In addition, the memory system 150 may also include a controller for controlling access to a memory of the accelerator core 140, for example, by a bus of the accelerator 130.

The memory processor 170 may be a device to perform an operation in the memory system 150 (typically, for computation on data stored in the memory system 150). The memory processor 170 may perform an operation for a predetermined purpose other than typical memory access operations. The memory processor 170 may include software (instructions, microcode, firmware, etc.) and/or hardware for the emulation 171. The memory processor 170 may include one or more of the instruction set 172, the ALU 173 (which may implement the instruction set 172), the instruction set 174 for the double-precision floating-point operation, and/or the ALU 175 for the double-precision floating-point operation (which the ALU 175 may implement). The instruction set 172 may be an instruction set to control the memory processor 170. An ALU may be a module for an arithmetic logic operation of the memory processor 170. The instruction set 174 may include instructions related to a double-precision floating-point operation. The ALU 175 may include an arithmetic logic operation used for a double-precision floating-point operation. Therefore, in a situation in which the accelerator 130 does not support directly perform a double-precision floating-point operation (e.g., its accelerator core lacks architectural support for double-precision primitives), the memory processor 170 may include an ALU and instructions for a double-precision floating-point emulation, and accordingly the accelerator 130 may perform a double-precision floating-point operation through emulation (and may implement discrete instruction(s) for same).

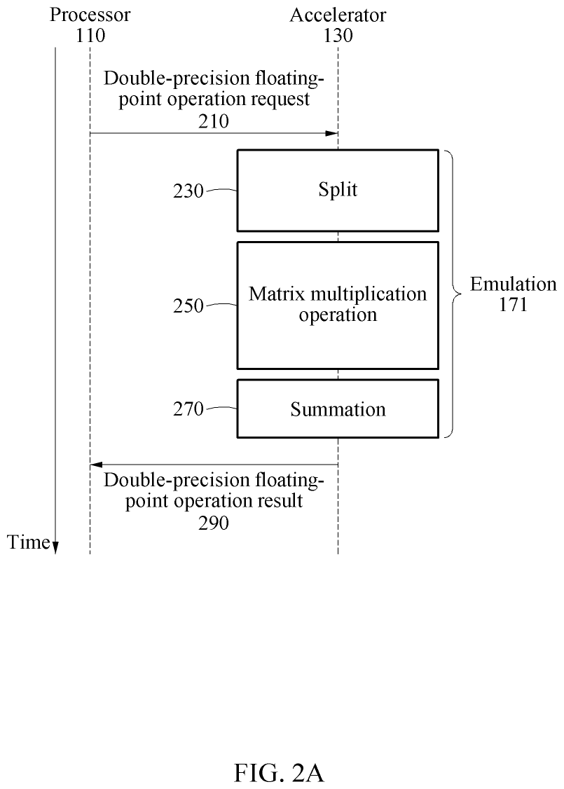

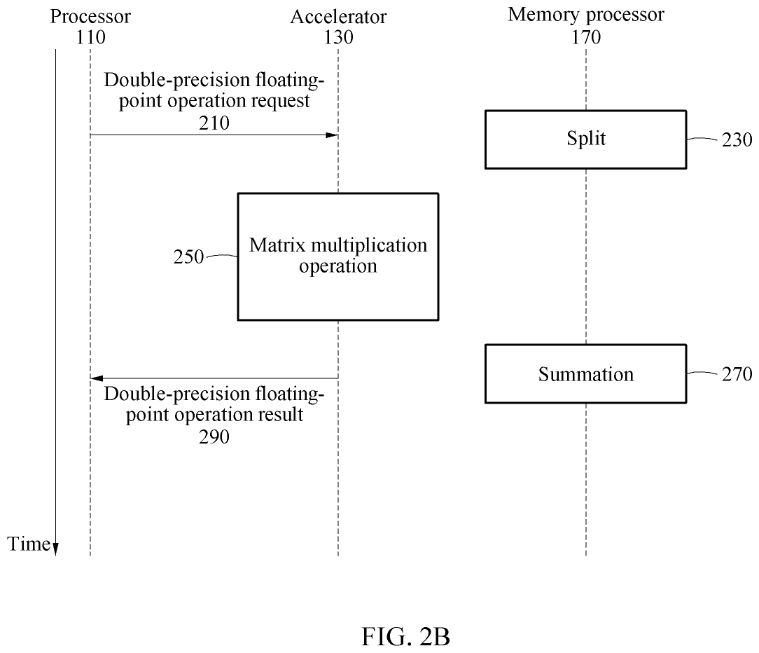

FIGS. 2A and 2B illustrate examples of an operation in which a portion of stages of a double-precision floating-point operation is performed in a memory processor, according to one or more embodiments.

A double-precision floating-point operation may be performed through an emulation. The emulation may include a plurality of operation stages. For example, the emulation may include one or more of a split stage, a matrix multiplication operation stage, and/or a summation stage. The emulation may further include other stages, or some stages may be omitted from the emulation. Emulation described below may include a split stage, a matrix multiplication operation stage, and/or a summation stage among a plurality of emulations. This is merely an example, and examples are not limited thereto.

The double-precision floating-point operation may include one or more of a split stage 230, a matrix multiplication operation stage 250, and/or a summation stage 270. The split stage 230 may be a stage of splitting a double-precision floating-point matrix into other matrices. For example, in the split stage 230, the double-precision floating-point matrix may be split into 20 sub-matrices. For example, in the split stage 230, a double-precision floating point number may be expressed as floating point numbers with precisions less than a double precision (e.g., FP16, FP32, etc.). The matrix multiplication operation stage 250 may be a multiplication operation between floating-point matrices with elements having a precision less than the double precision. The summation stage 270 may be a stage of summing multiplication results between floating-point matrices with elements having a precision less than the double precision, which may produce a double-precision result of the multiplication operation.

Referring to FIG. 2A, the processor 110 may transmit a double-precision floating-point operation request 210 (e.g., an opcode or instruction for a double-precision floating point operation) to the accelerator 130. The accelerator 130 may receive the double-precision floating-point operation request 210 and perform the requested double-precision floating-point operation. However, when the accelerator 130 does not directly support a double-precision floating-point operation (e.g., as a native operation), emulation 171 may be used for carrying out the requested double-precision floating-point operation. Accordingly, the accelerator 130 may perform the requested double-precision floating-point operation through the split stage 230, the matrix multiplication operation stage 250, and the summation stage 270 of the emulation 171.

Memory input/output (I/O) overhead may occur in the split stage 230. Accordingly, an acceleration scheme of the split stage 230 may be used. In particular, the split stage 230 may occupy about 30% of a total time for the double-precision floating-point operation. Therefore, to reduce a time for the double-precision floating-point operation, the acceleration scheme of the split stage 230 may be used. When the memory processor 170 is used, a delay caused by a bandwidth limit in data transmission between the accelerator 130 and a memory may be avoided, which may increase speed and overall hardware utilization. In other words, by offloading to the memory processor 170 one or more of the stages used for the emulating the double-precision floating-point operation, the delay caused by the upper bandwidth limit may be solved. For example, when a large amount of data is repeatedly exchanged between the accelerator 130 and the memory, a delay may be caused by the bandwidth limit. However, when the memory processor 170 has an operation portion included in the memory, such exchanges may be reduced, for example, for floating point emulation.

Referring to FIG. 2B, the split stage 230 and the summation stage 270 are performed by the memory processor 170. FIG. 2B is merely an example, and one or more of the split stage 230, the matrix multiplication operation stage 250, and/or the summation stage 270 included in the double-precision floating-point operation may be performed by the memory processor 170.

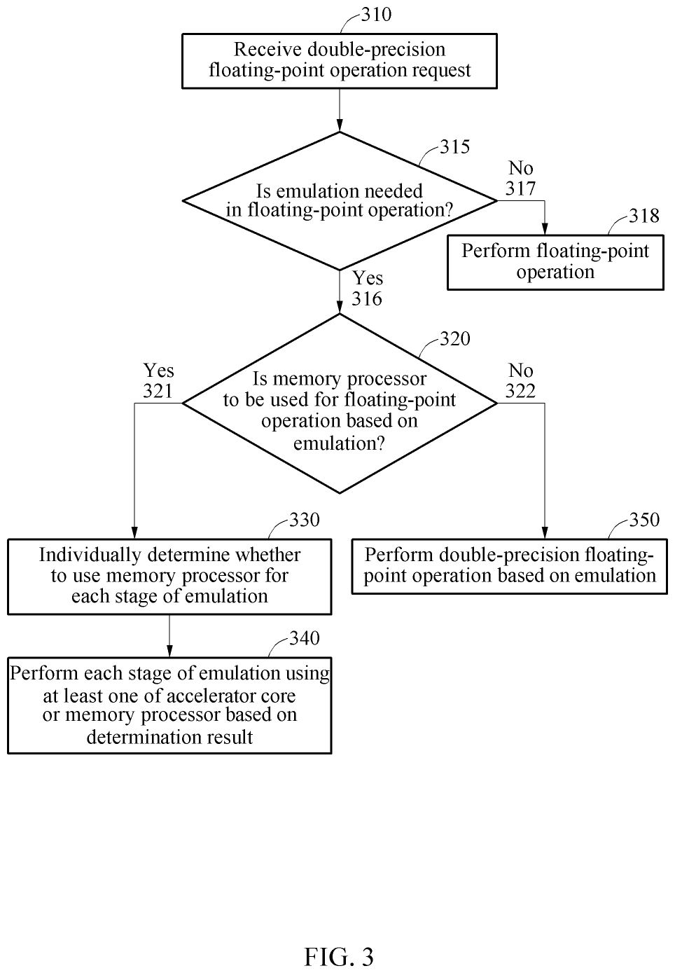

FIG. 3 illustrates an example of determining whether to use a memory processor in executing a double-precision floating-point operation, according to one or more embodiments.

In operation 310, the accelerator 130 may receive a double-precision floating-point operation request from the processor 110. For example, the request may include a double-precision instruction having a double-precision opcode and references to double-precision operands. In operation 315, the accelerator 130 may determine whether emulation is to be used for the requested floating-point operation. The accelerator 130 may determine whether emulation is needed, based on whether an electronic device supports the double-precision floating-point operation in hardware or software (e.g., by invoking a special instruction, checking register value, etc.). For example, if the electronic device natively supports a number system of double-precision floating points, the emulation may not be needed for executing the requested double-precision floating-point operation. When the electronic device does not support the double-precision floating-point operation, the double-precision floating-point operation may be performed using emulation. However, when the electronic device supports the double-precision floating-point operation (e.g., in hardware or software), the accelerator 130 may perform a floating-point operation (e.g., using its ALU) instead of using emulation.

In an example, when emulation is not needed for the floating-point operation in operation 317, the accelerator 130 may perform the floating-point operation without using emulation in operation 318. In another example, when emulation is to be used to perform the requested floating-point operation in operation 316, the accelerator 130 may perform operation 320.

In operation 320, the accelerator 130 may determine whether to use the memory processor (e.g., in or near memory computing) to emulate the floating-point operation. The accelerator 130 may determine whether to use the memory processor 170 based on, for example, a size of a matrix, a size of a sub-matrix, a number of sub-matrices, etc. In a splitting stage, a first matrix may be split into first sub-matrices and a second matrix may be split into second sub-matrices based on whether to use the memory processor 170. The split stage 230 may be performed by the accelerator 130 or the memory processor 170 (although data being split may remain in the memory portion of the memory processor 170).

Generally, a matrix may be a double-precision floating-point matrix (i.e., may have double-precision elements), and a sub-matrix may be a floating-point matrix with a precision less than a double precision (i.e., with lower-precision elements). The matrix may be represented by sub-matrices (i.e., may be split into sub-matrices).

The size of an arbitrary matrix may be a size of a double-precision floating-point matrix and may be determined based on a representation range of double-precision floating-point numbers (i.e., the range of represented exponents). For example, the size of a matrix may be determined based on a number of rows of the matrix, a number of columns of the matrix, sizes of elements included in the matrix, and so forth. The sizes of the elements may be determined based on ranges of double-precision floating-point numbers. In an example, when the ranges of double-precision floating-point numbers increase, the size of a matrix may correspondingly increase. This is because the size of a matrix may be determined based on “(number of rows)×(number of columns)×(sizes of elements)”, and the sizes of the elements increase if the range of double-precision floating-point numbers increases. In another example, when the representation range of double-precision floating-point numbers decreases, the size of the matrix may correspondingly decrease.

A sub-matrix may be a floating-point matrix with a precision less than the double precision. The size of a sub-matrix may be determined based on a representation range of its floating-point numbers; the sub-matrix may have a precision less than double precision. The number of sub-matrices needed to store the data of a double precision matrix may be determined based on a range of double-precision floating-point numbers. In an example, when the range of double-precision floating-point numbers increases, the number of sub-matrices correspondingly increases. In another example, when the range of double-precision floating-point numbers decreases, the number of sub-matrices may correspondingly decrease.

The number of sub-matrices may be the number of sub-matrices generated by splitting a matrix in the splitting stage 230. The number of sub-matrices may be determined based on a number of first sub-matrices or a number of second sub-matrices. For example, when the first matrix (e.g., a first operand of the requested floating point operation) is split into 20 first sub-matrices and when the second matrix (e.g., a second operand of the requested floating point operation) is split into 20 second sub-matrices, the number of sub-matrices may be 40. When the number of sub-matrices increases, an amount of operations used for a matrix multiplication operation stage may increase. For example, when the number of first sub-matrices is 20 and the number of second sub-matrices is 20, 400 matrix multiplication operation results may be generated. Accordingly, when the number of sub-matrices increases, an amount of operations for the matrix multiplication operation stage 250 may increase.

In operation 321, the accelerator 130 may determine to use the memory processor 170 for emulating the requested double-precision floating-point operation. In operation 330, the accelerator 130 may individually determine whether to use the memory processor for each stage of the emulation (stages not performed by the memory processor may be performed by the accelerator core 140, for example). For example, the accelerator 130 may determine whether to use the memory processor in the split stage, whether to use the memory processor in the matrix multiplication operation stage, and/or whether to use the memory processor in the summation stage (each may be individually determined apart from the others).

The accelerator 130 may determine whether to use the memory processor 170 in the split stage based on, for example, a comparison between a size of a sub-matrix and a memory bandwidth. The memory bandwidth may be a bandwidth (e.g., available or maximum) between the accelerator core 140 and the memory system 150. Sub-matrices may need to be transmitted to the memory system 150 all at once, instead of being sent over multiple transmissions. However, when the size of the sub-matrix is greater than the memory bandwidth, the sub-matrix may be transmitted to the memory system 150 only by using multiple transmissions, which may cause a delay. Accordingly, the accelerator 130 may use the memory processor 170 when doing so falls within a range in which a delay does not occur due to a use of the memory processor 170. In an example, when the size of the sub-matrix is less than the memory bandwidth, the accelerator 130 may determine to use the memory processor 170 in the splitting stage. In another example, when the size of the sub-matrix is greater than the memory bandwidth, the split stage may be performed using the accelerator core 140.

The accelerator 130 may determine whether to use the memory processor 170 in the matrix multiplication operation stage based on either the number of sub-matrices or a number of floating-point operations performed per second (FLOPS), for example. The accelerator 130 may predict a matrix multiplication operation time based on the number of sub-matrices and the FLOPS. Accordingly, the accelerator 130 may determine whether it is more advantageous to perform the matrix multiplication operation stage in the accelerator core 140 or in the memory processor 170. This is because a floating-point operation of the accelerator core 140 and a floating-point operation of the memory processor 170 may be different from each other (may take different amounts of time for the same floating-point operation).

The accelerator 130 may determine whether to use the memory processor 170 in the summation stage based on a comparison between the size of a sub-matrix and the memory bandwidth. The accelerator 130 may determine to use the memory processor 170 within a size of a sub-matrix falls within a range for which a delay will not occur due to the use of the memory processor 170. In an example, when the size of a sub-matrix is less than the memory bandwidth, the accelerator 130 may determine to use the memory processor 170 in the summation stage. In another example, when the size of the sub-matrix is greater than the memory bandwidth, the summation stage may be performed using the accelerator core 140.

In operation 340, the accelerator 130 may perform each stage of the emulation using either the accelerator core 140 or the memory processor 170, according to the results of operation 330. Therefore, whether each stage (e.g., a split stage, a matrix multiplication operation stage, and a summation stage) in the emulation is to be performed by the accelerator core 140 or the memory processor 170 may be determined, so that the requested floating-point operation may be performed efficiently using available resources.

In operation 322, the accelerator 130 may determine not to use the memory processor 170 for the floating-point operation emulation. In operation 350, the accelerator 130 may perform the requested double-precision floating-point operation by using emulation that is performed/executed by the accelerator core 140.

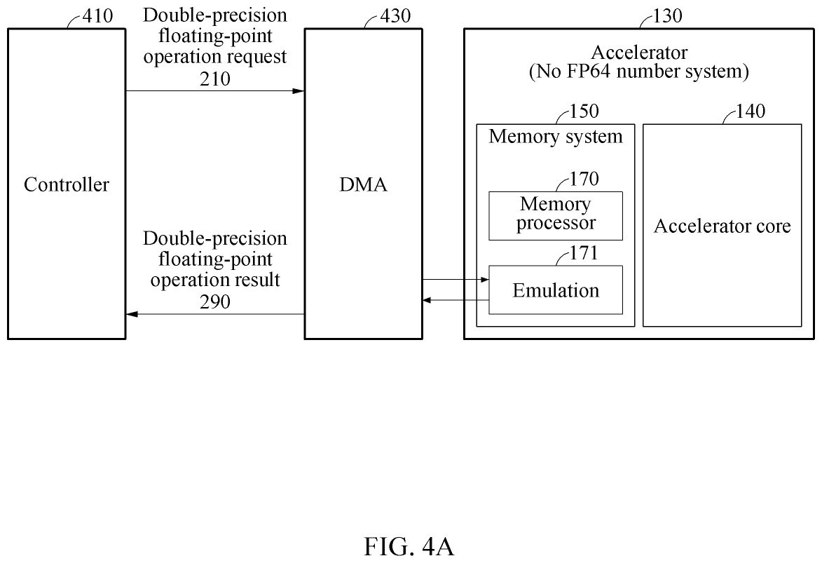

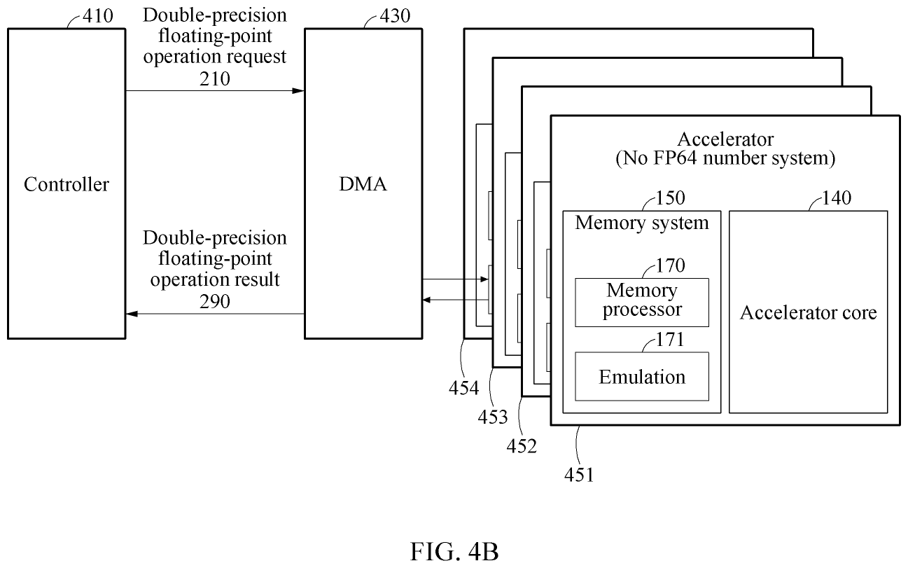

FIGS. 4A and 4B illustrate examples of performing a double-precision floating-point operation using a direct memory access (DMA), according to one or more embodiments.

A DMA 430 may be a process or a module that transmits data without an intervention of a processor itself. For example, the DMA 430 may be an engine and may automatically perform memory transfers based on instructions. A controller 410 may be a CPU (e.g., the processor 110). The DMA 430 may receive a double-precision floating-point operation request 210 from the controller 410. Based on the request, the DMA 430 may process the requested double-precision floating-point operation using a memory processor 170 of a memory system 150 included in an accelerator 130. For example, when the memory processor 170 is used for a floating-point operation, the controller 410 may multiply a first matrix and a second matrix by controlling at least one memory processor 170 using the DMA 430 to transfer data. In an example, as shown in FIG. 4A, the DMA 430 may multiply the first matrix and the second matrix by controlling a single accelerator, for example, the accelerator 130 including the memory processor 170. In another example, as shown in FIG. 4B, the DMA 430 may multiply the first matrix and the second matrix by controlling a plurality of accelerators 451, 452, 453, and 454 that each include a memory processor.

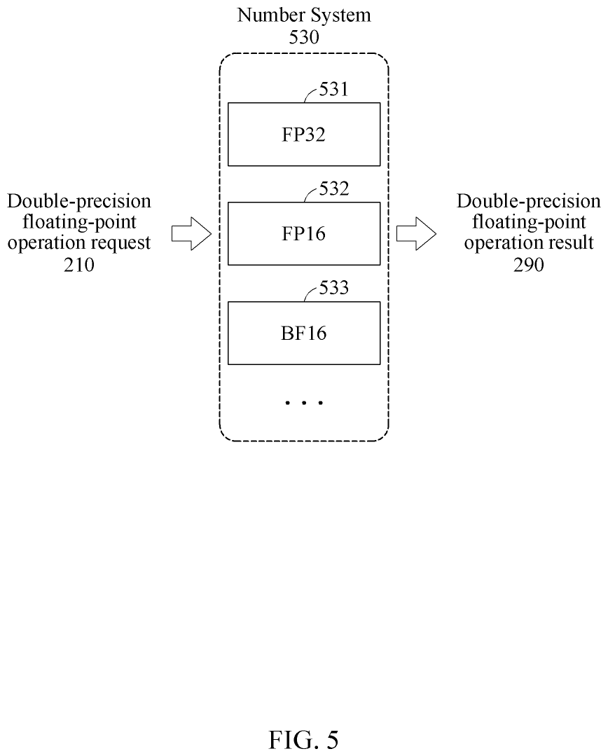

FIG. 5 illustrates an example in which a double-precision floating-point operation may be performed by an operation device with various number systems, according to one or more embodiments.

A number system 530 may be a system of number representation supported by the accelerator 130. The accelerator 130 may have the number system 530 with a precision less than a double precision. For example, the accelerator 130 may be a device that supports at least one of a 32-bit floating point (FP32) operation 531, an FP16 operation 532, a 16-bit brain floating point (BF16) operation 533, or a tensor-float-32 (TF32) operation.

Accordingly, a double-precision floating-point operation may be performed by a device (or an accelerator) that supports a floating-point operation with a precision less than the double precision. In an example, a first matrix and a second matrix may be double-precision floating-point (FP64) matrices. In another example, the first matrix and the second matrix may be FP128. If FP128 is not supported in hardware, an FP128 operation may be performed using a floating-point operator with a precision less than FP128. In addition, a sub-matrix obtained by splitting a matrix may correspond to at least one of FP32, FP16, BF16, or TF32 with a precision less than the double precision. The absolute sizes of the floating points described herein are not limiting; the techniques and devices described herein may be used to allow the accelerator 130 to implement (through emulation) a floating point precision that is larger than the native (non-emulated) floating point precision of the accelerator 130. Moreover, the emulated precision may be varying multiples of the native precision.

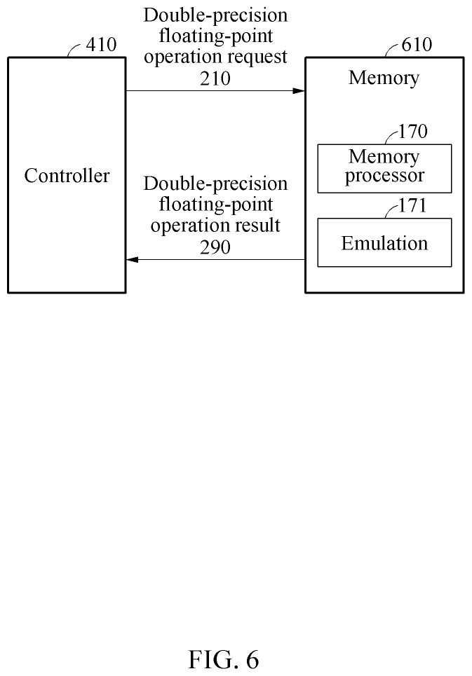

FIG. 6 illustrates an example of an operation of performing a double-precision floating-point operation using a processor, according to one or more embodiments.

A memory 610 shown in FIG. 6 may correspond to the memory 830 shown in FIG. 8. The memory 610 may be a memory that exists outside the accelerator 130. Accordingly, the memory 610 may be distinguished from the memory system 150 shown in FIG. 1.

For example, the accelerator 130 may not be present/included or may not be used in a double-precision floating-point operation. In this example, the operation of the accelerator 130 described above with reference to FIGS. 1 through 5 may be performed by the controller 410 (e.g., the processor 110). Accordingly, it may be the controller 410 that determines whether to use the memory processor 170 in each/any stage of the double-precision floating-point operation. For example, the controller 410 may assign a split stage to the memory processor 170, and may perform a matrix multiplication operation stage. The controller 410 may transmit a split stage operation request to the memory 610. In addition, the memory processor 170 may process the split stage and transmit an operation result to the controller 410. The controller 410 may receive the operation result and perform a next stage of the double-precision floating-point operation.

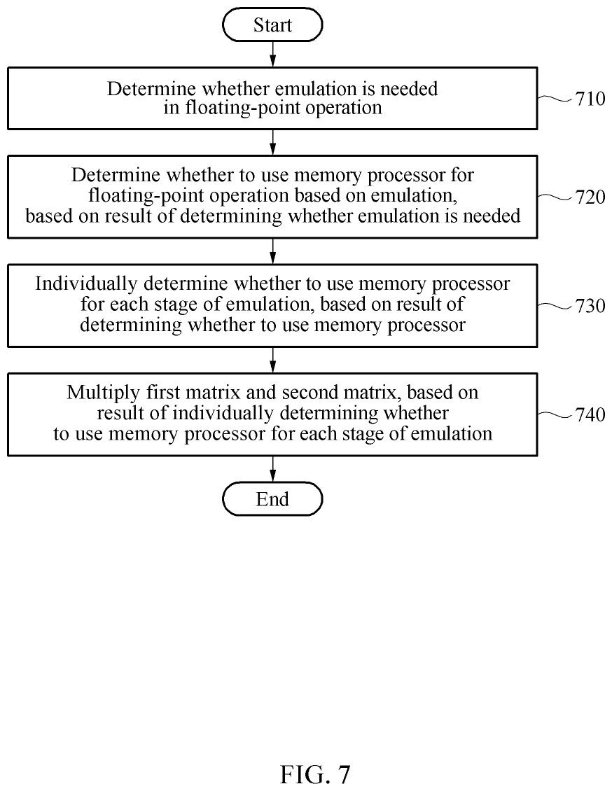

FIG. 7 illustrates an example of a method of performing a double-precision floating-point operation using a memory processor, according to one or more embodiments.

In operation 710, an electronic device (e.g., an electronic device 801 of FIG. 8) may determine whether emulation is needed in a floating-point operation.

In operation 720, based on a result of determining whether the emulation is needed, the electronic device 801 may determine whether to use the memory processor for the floating-point operation based on the emulation.

In operation 730, based on a result of determining whether to use the memory processor, the electronic device 801 may individually determine whether to use the memory processor for each stage of the emulation.

In operation 740, the electronic device 801 may multiply a first matrix and a second matrix based on a result of individually determining whether to use the memory processor for each stage of the emulation.

Operation 710 of determining whether the emulation is needed may be based on whether the electronic device supports a double-precision floating-point operation in hardware or software.

The emulation may include a split stage, a matrix multiplication operation stage, and a summation stage.

The floating-point operation using emulation may include (i) a stage of splitting the first matrix into first sub-matrices and splitting the second matrix into second sub-matrices based on whether to use the memory processor in the split stage, (ii) a stage of calculating matrix products between the first sub-matrices and the second sub-matrices based on whether to use the memory processor in the matrix multiplication operation stage, and (iii) a stage of summing the matrix products based on whether to use the memory processor in the summation stage.

Operation 720 of determining whether to use the memory processor for the floating-point operation may include determining whether to use the memory processor, based on one or more of a size of a matrix, a size of a sub-matrix, or a number of sub-matrices.

The size of the matrix may include at least one of a size of the first matrix or a size of the second matrix. The number of sub-matrices may be determined based on one or more of a number of first sub-matrices or a number of second sub-matrices.

The size of the matrix may be determined based on one or more of a number of rows of the matrix, a number of columns of the matrix, or sizes of elements included in the matrix. The sizes of the elements may be determined based on ranges of double-precision floating-point numbers.

The number of sub-matrices may be determined based on a range of double-precision floating-point numbers.

Operation 730 of determining whether to use the memory processor for each stage of the emulation may include one or more of determining whether to use the memory processor in the split stage, determining whether to use the memory processor in the matrix multiplication operation stage, or determining whether to use the memory processor in the summation stage.

Whether to use the memory processor in the split stage may be determined based on a comparison between a size of a sub-matrix and a memory bandwidth.

When the size of the sub-matrix is less than the memory bandwidth, it may be determined to use the memory processor in the split stage.

Whether to use the memory processor in the matrix multiplication operation stage may be determined based on at least one of a number of sub-matrices or FLOPS.

Whether to use the memory processor in the summation stage may be determined based on a comparison between a size of a sub-matrix and a memory bandwidth.

Operation 740 of multiplying the first matrix and the second matrix may include multiplying the first matrix and the second matrix by controlling at least one memory processor through a DMA when the memory processor is used in the floating-point operation.

The first matrix and the second matrix may correspond to FP64, and a sub-matrix obtained by splitting the matrix may correspond to at least one of FP32, FP16, BF16, or TF32.

FIG. 8 illustrates an example of an electronic device, according to one or more embodiments.

FIG. 8 illustrates the electronic device 801 in a network environment 800. Referring to FIG. 8, the electronic device 801 in the network environment 800 may communicate with an electronic device 802 via a first network 898 (e.g., a short-range wireless communication network), or communicate with at least one of an electronic device 804 or a server 808 via a second network 899 (e.g., a long-range wireless communication network). According to an example, the electronic device 801 may communicate with the electronic device 804 via the server 808. According to an example, the electronic device 801 may include a processor 820, the memory 830, an input module 850, a sound output module 855, a display module 860, an audio module 870, a sensor module 876, an interface 877, a connecting terminal 878, a haptic module 879, a camera module 880, a power management module 888, a battery 889, a communication module 890, a subscriber identification module (SIM) 896, or an antenna module 897. In some examples, at least one of the components (e.g., the connecting terminal 878) may be omitted from the electronic device 801, or one or more other components may be added to the electronic device 801. In some examples, some of the components (e.g., the sensor module 876, the camera module 880, or the antenna module 897) may be integrated as a single component (e.g., the display module 860).

The processor 820 may execute, for example, software (e.g., a program 840) in the form of machine-executable instructions to control at least one other component (e.g., a hardware or software component) of the electronic device 801 connected to the processor 820, and may perform various data processing or computation. According to an example, as at least a part of data processing or computation, the processor 820 may store a command or data received from another component (e.g., the sensor module 876 or the communication module 890) in a volatile memory 832, process the command or the data stored in the volatile memory 832, and store resulting data in a non-volatile memory 834. According to an example, the processor 820 may include the main processor 821 (e.g., a CPU or an application processor (AP)), or an auxiliary processor 823 (e.g., a GPU, an NPU, an ISP, a sensor hub processor, or a CP) that is operable independently from, or in conjunction with the main processor 821. For example, when the electronic device 801 includes the main processor 821 and the auxiliary processor 823, the auxiliary processor 823 may be adapted to consume less power than the main processor 821 or to be specific to a specified function. The auxiliary processor 823 may be implemented separately from the main processor 821 or as a part of the main processor 821.

The auxiliary processor 823 may control at least some of functions or states related to at least one (e.g., the display module 860, the sensor module 876, or the communication module 890) of the components of the electronic device 801, instead of the main processor 821 while the main processor 821 is in an inactive (e.g., sleep) state or along with the main processor 821 while the main processor 821 is an active state (e.g., executing an application). According to an example, the auxiliary processor 823 (e.g., an ISP or a CP) may be implemented as a portion of another component (e.g., the camera module 880 or the communication module 890) that is functionally related to the auxiliary processor 823. According to an example, the auxiliary processor 823 (e.g., an NPU) may include a hardware structure specified for processing of an artificial intelligence (AI) model. The AI model may be generated by machine learning. Such learning may be performed by, for example, the electronic device 801 in which an AI model is executed, or performed via a separate server (e.g., the server 808). A learning algorithm may include, but is not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may additionally or alternatively include a software structure other than the hardware structure.

The memory 830 may store various pieces of data used by at least one component (e.g., the processor 820 or the sensor module 876) of the electronic device 801. The various pieces of data may include, for example, software (e.g., the program 840) and input data or output data for a command related thereto. The memory 830 may include the volatile memory 832 or the non-volatile memory 834.

The program 840 may be stored as instructions in the memory 830, and may include, for example, an operating system (OS) 842, middleware 844, or an application 846.

The input module 850 may receive a command or data to be used by another component (e.g., the processor 820) of the electronic device 801, from the outside (e.g., a user) of the electronic device 801. The input module 850 may include, for example, a microphone, a mouse, a keyboard, a key (e.g., a button), or a digital pen (e.g., a stylus pen).

The sound output module 855 may output a sound signal to the outside of the electronic device 801. The sound output module 855 may include, for example, a speaker or a receiver. The speaker may be used for general purposes, such as playing multimedia or playing record. The receiver may be used to receive an incoming call. According to an example, the receiver may be implemented separately from the speaker or as a part of the speaker.

The display module 860 may visually provide information to the outside (e.g., a user) of the electronic device 801. The display module 860 may include, for example, a display, a hologram device, or a projector and control circuitry to control a corresponding one of the display, the hologram device, and the projector. According to an example, the display module 860 may include a touch sensor adapted to sense a touch, or a pressure sensor adapted to measure an intensity of a force incurred by the touch.

The audio module 870 may convert a sound into an electric signal and vice versa. According to an example, the audio module 870 may obtain the sound via the input module 850 or output the sound via the sound output module 855 or an external electronic device (e.g., the electronic device 802 such as a speaker or a headphone) directly or wirelessly connected to the electronic device 801.

The sensor module 876 may detect an operational state (e.g., power or temperature) of the electronic device 801 or an environmental state (e.g., a state of a user) external to the electronic device 801, and generate an electrical signal or data value corresponding to the detected state. According to an example, the sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device (e.g., the electronic device 802) directly (e.g., by wire) or wirelessly. According to an example, the interface 877 may include, for example, a high-definition multimedia interface (HDMI), a universal serial bus (USB) interface, a secure digital (SD) card interface, or an audio interface.

The connecting terminal 878 may include a connector via which the electronic device 801 may be physically connected to an external electronic device (e.g., the electronic device 802). According to an example, the connecting terminal 878 may include, for example, an HDMI connector, a USB connector, an SD card connector, or an audio connector (e.g., a headphone connector).

The haptic module 879 may convert an electric signal into a mechanical stimulus (e.g., a vibration or a movement) or an electrical stimulus which may be recognized by a user via his or her tactile sensation or kinesthetic sensation. According to an example, the haptic module 879 may include, for example, a motor, a piezoelectric element, or an electric stimulator.

The camera module 880 may capture a still image and moving images. According to an example, the camera module 880 may include one or more lenses, image sensors, ISPs, or flashes.

The power management module 888 may manage power supplied to the electronic device 801. According to an example, the power management module 888 may be implemented as, for example, at least a part of a power management integrated circuit (PMIC).

The battery 889 may supply power to at least one component of the electronic device 801. According to an example, the battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more CPs that are operable independently of the processor 820 (e.g., an AP) and that support a direct (e.g., wired) communication or a wireless communication. According to an example, the communication module 890 may include a wireless communication module 892 (e.g., a cellular communication module, a short-range wireless communication module, or a global navigation satellite system (GNSS) communication module) or a wired communication module 894 (e.g., a local area network (LAN) communication module, or a power line communication (PLC) module). A corresponding one of these communication modules may communicate with the external electronic device 804 via the first network 898 (e.g., a short-range communication network, such as Bluetooth™, wireless-fidelity (Wi-Fi) direct, or infrared data association (IrDA)) or the second network 899 (e.g., a long-range communication network, such as a legacy cellular network, a 5G network, a next-generation communication network, the Internet, or a computer network (e.g., a LAN or a wide region network (WAN)). These various types of communication modules may be implemented as a single component (e.g., a single chip), or may be implemented as multi components (e.g., multi chips) separate from each other. The wireless communication module 892 may identify and authenticate the electronic device 801 in a communication network, such as the first network 898 or the second network 899, using subscriber information (e.g., international mobile subscriber identity (IMSI)) stored in the SIM 896.

The wireless communication module 892 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 892 may support a high-frequency band (e.g., a mmWave band) to achieve, e.g., a high data transmission rate. The wireless communication module 892 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 892 may support various requirements specified in the electronic device 801, an external electronic device (e.g., the electronic device 804), or a network system (e.g., the second network 899). According to an example, the wireless communication module 892 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 897 may transmit or receive a signal or power to or from the outside (e.g., an external electronic device) of the electronic device 801. According to an example, the antenna module 897 may include an antenna including a radiating element including a conductive material or a conductive pattern formed in or on a substrate (e.g., a printed circuit board (PCB)). According to an example, the antenna module 897 may include a plurality of antennas (e.g., array antennas). In such a case, at least one antenna appropriate for a communication scheme used in a communication network, such as the first network 898 or the second network 899, may be selected by, for example, the communication module 890 from the plurality of antennas. The signal or power may be transmitted or received between the communication module 890 and the external electronic device via the at least one selected antenna. According to an example, another component (e.g., a radio frequency integrated circuit (RFIC)) other than the radiating element may be additionally formed as a part of the antenna module 897.

According to examples, the antenna module 897 may form a mmWave antenna module. According to an example, the mmWave antenna module may include a PCB, an RFIC disposed on a first surface (e.g., a bottom surface) of the PCB or adjacent to the first surface and capable of supporting a designated high-frequency band (e.g., a mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MI PI)).

According to an example, commands or data may be transmitted or received between the electronic device 801 and the external electronic device 804 via the server 808 coupled with the second network 899. Each of the external electronic devices 802 or 804 may be a device of the same type as or a different type from the electronic device 801. According to an example, all or some of operations to be executed by the electronic device 801 may be executed at one or more external electronic devices (e.g., the external electronic devices 802 and 804, and the server 808). For example, if the electronic device 801 needs to perform a function or a service automatically, or in response to a request from a user or another device, the electronic device 801, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer an outcome of the performing to the electronic device 801. The electronic device 801 may provide the outcome, with or without further processing of the outcome, as at least part of a reply to the request. To that end, a cloud computing, distributed computing, mobile edge computing (MEC), or client-server computing technology may be used, for example. The electronic device 801 may provide ultra low-latency services using, e.g., distributed computing or MEC. In an example, the external electronic device 804 may include an Internet-of-things (IoT) device. The server 808 may be an intelligent server using machine learning and/or a neural network. According to an example, the external electronic device 804 or the server 808 may be included in the second network 899. The electronic device 801 may be applied to intelligent services (e.g., a smart home, a smart city, a smart car, or healthcare) based on 5G communication technology or IoT-related technology.

It should be appreciated that various examples of the disclosure and the terms used therein are not intended to limit the technological features set forth herein to particular examples and include various changes, equivalents, or replacements for a corresponding example. In connection with the description of the drawings, like reference numerals may be used for similar or related components. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” may include any one of the items listed together in the corresponding one of the phrases, or all possible combinations thereof. Terms such as “1st” and “2nd,” or “first” and “second” may be used to simply distinguish a corresponding component from other components, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various examples of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an example, the module may be implemented in a form of an application-specific integrated circuit (ASIC).

Various examples as set forth herein may be implemented as software (e.g., the program 840) including one or more instructions that are stored in a storage medium (e.g., the internal memory 836 or the external memory 838) that is readable by a machine (e.g., the electronic device 801) For example, a processor (e.g., the processor 820) of the machine (e.g., the electronic device 801) may invoke at least one of the one or more instructions stored in the storage medium, and execute it. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

An example method of the disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various examples, each component (e.g., a module or a program) of the above-described components may include a single entity or multiple entities, and some of the multiple entities may be separately disposed in different components. According to examples, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to an example, operations performed by the module, the program, or another component may be carried out sequentially, in parallel, repeatedly, or heuristically, or one or more of the operations may be executed in a different order or omitted, or one or more other operations may be added.

The computing apparatuses, the electronic devices, the processors, the memories, the information output system and hardware, the storage devices, and other apparatuses, devices, units, modules, and components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of performing a floating-point operation using a memory processor, the floating-point operation being a multiplication of a first matrix and a second matrix that are double-precision floating-point matrices, the method comprising:
determining whether an emulation is to be used to perform the floating-point operation;
based on a result of the determining whether the emulation is to be used, determining whether to use the memory processor for the emulation, the emulation comprising stages;
based on a result of the determining whether to use the memory processor for the emulation, individually determining whether to use the memory processor for each stage of the emulation; and
multiplying the first matrix and the second matrix based on a result of the individually determining whether to use the memory processor.

2. The method of claim 1, wherein the determining whether the emulation is to be used is based on whether an electronic device supports a double-precision floating-point operation.

3. The method of claim 1, wherein the stages comprise a splitting stage, a matrix multiplication operation stage, and a summation stage.

4. The method of claim 3, wherein:
the splitting stage comprises splitting the first matrix into a plurality of first sub-matrices and splitting the second matrix into a plurality of second sub-matrices;
the matrix multiplication operation stage comprises calculating matrix products between the first sub-matrices and the second sub-matrices; and
the summation stage comprises summing the matrix products.

5. The method of claim 1, wherein
the determining of whether to use the memory processor for the emulation is based on at least one of a size of a matrix, a size of a sub-matrix, or a number of sub-matrices,
the size of the matrix comprises at least one of a size of the first matrix or a size of the second matrix, and
the number of sub-matrices is determined based on at least one of a number of first sub-matrices or a number of second sub-matrices.

6. The method of claim 5, wherein the size of the matrix is determined based on at least one of a number of rows of the matrix, a number of columns of the matrix, or sizes of elements included in the matrix, wherein the sizes of the elements are determined based on ranges of double-precision floating-point numbers.

7. The method of claim 5, wherein the number of sub-matrices is determined based on a range of double-precision floating-point numbers.

8. The method of claim 1, wherein the individually determining whether to use the memory processor for each stage of the emulation comprises at least one of:
determining whether to use the memory processor in a split stage;
determining whether to use the memory processor in a matrix multiplication operation stage; or
determining whether to use the memory processor in a summation stage.

9. The method of claim 8, wherein the determining of whether to use the memory processor in the split stage is based on a comparison between a size of a sub-matrix and a memory bandwidth.

10. The method of claim 9, wherein the memory processor is determined to be used in the split stage when the size of the sub-matrix is less than the memory bandwidth.

11. The method of claim 8, wherein the determining of whether to use the memory processor in the matrix multiplication operation stage is based on at least one of a number of sub-matrices or floating-point operations per second (FLOPS).

12. The method of claim 8, wherein the determining of whether to use the memory processor in the summation stage is based on a comparison between a size of a sub-matrix and a memory bandwidth.

13. The method of claim 1, wherein the multiplying of the first matrix and the second matrix is controlled by at least one memory processor through a direct memory access (DMA) when the memory processor is used for the emulation.

14. The method of claim 1, wherein
the first matrix and the second matrix correspond to 64-bit floating point (FP64), and
a sub-matrix obtained by splitting the matrix corresponds to at least one of 32-bit floating point (FP32), 16-bit floating point (FP16), 16-bit brain floating point (BF16), or tensor-float-32 (TF32).

15. A non-transitory computer-readable storage medium storing instructions that, when executed by a processor, cause the processor to perform the method of claim 1.

16. An accelerator for performing a floating-point operation by receiving a floating-point operation request from a processor, the accelerator comprising:
an accelerator core;
a memory system; and
a memory processor included in the memory system,
wherein the accelerator is configured to:
determine whether an emulation is to be used to perform the floating-point operation;
based on a result of the determining whether the emulation is to be used, determine whether to use the memory processor for the emulation, the emulation comprising stages;
based on a result of the determining whether to use the memory processor for the emulation, individually determine whether to use the memory processor for each stage of the emulation; and
multiply a first matrix and a second matrix based on a result of the individually determining whether to use the memory processor.

17. A computing device for a floating-point operation, the computing device comprising:
a processor;
a memory; and
a memory processor included in the memory,
wherein the processor, for performing the floating-point operation, is configured to:
determine whether an emulation is needed for performing the floating-point operation;
based on a result of the determining whether the emulation is needed, determine whether to use the memory processor for the emulation, wherein the emulation comprises stages;
based on a result of determining whether to use the memory processor for the emulation, individually determine whether to use the memory processor for each stage of the emulation; and
multiply a first matrix and a second matrix based on a result of the individually determining whether to use the memory processor.

18. The computing device of claim 17, wherein the memory comprises a memory chip, and wherein the memory chip comprises a memory portion and the memory processor.

19. The computing device of claim 18, wherein the memory is configured such that the memory processor is capable of performing the multiplying on the first matrix and the second matrix stored while they first matrix and second matrix are stored in the memory portion.
